(19) United States
(12) Patent Application Publication
(10) Pub. No.: US 2017/0099393 A1
(43) Pub. Date: Apr. 6, 2017

(54) Monitoring Device Geolocations

(71) Applicant: eComputer Inc., Elmhurst, IL (US)

(72) Inventors: Robert W. Chvatal, Downers Grove, IL (US); John Mastro, Arlington Heights, IL (US); Brian P. Pautsch, Orland Park, IL (US); Christopher William Pautsch, Downers Grove, IL (US)

(73) Assignee: eComputer Inc., Elmhurst, IL (US)

(21) Appl. No.: 14/875,121

(22) Filed: Oct. 5, 2015

(51) Int. Cl. H04M 15/00; H04W 4/24; H04W 4/02

(52) U.S. Cl. CPC H04M 15/8038; H04W 4/021; H04W 4/24; H04M 15/83; H04M 2215/34

(57) ABSTRACT

A system for monitoring device geolocations may enable a mobile device to operate effectively as the device moves across various coverage areas. The system may include a server that receives geolocation data from a mobile device and modifies one or more service plans associated with the device based on the geolocation data. The mobile device may include application software for communicating with the server. The system may also include an administration application that notifies an administrator when a change in a device's geolocation may trigger an action item. The administrator may act on the action item, for example, by modifying one or more service plans associated with the device to enable or disable certain account for the change in the device's location.

### BACKGROUND OF THE INVENTION

1. Technical Field

The present application relates to monitoring device geolocations locations and modifying associated billing methodologies. 2. Related Art

Mobile devices such as cell phones are a lifeline for today's business travelers. Whether it be to check email, review and/or edit documents, access remote systems and services, check their calendars, or even to simply make a phone call, mobile devices are ubiquitous across the corporate hierarchy. And while mobile devices have untethered employees from their offices and created a plethora of new technologies and capabilities, they've also created some unique technological problems.

One technical problem unique to mobile devices relates to their coverage areas. Unlike legacy land-lines, mobile devices such as cell phones may be moved anywhere in the world. As the device matriculates outside of a service area associated with the device, for example, further use of the device may incur hefty roaming charges. In some cases, certain functionality such as data transfers and/or certain types of call activity may be disabled altogether. Users most likely to be affected by this problem are typically busy executives or other workers that routinely travel across coverage areas, such as state to state, region to region, or country to country. Because these trips often occurs with little or no advanced notice and the employee is typically preoccupied with the urgent business concerns of the moment, the problem is not recognized until device stops working, leaving the employee adrift in a strange land with no way to call (or email or text) home.

Accordingly, a need has long existed for improved systems and methods for monitoring a device's geolocation.

### SUMMARY

In one embodiment, a system for monitoring device geolocations may enable a mobile device to operate effectively as the device moves across various coverage areas. The system may include a server that receives geolocation data from a mobile device and modifies one or more service plans associated with the device based on the geolocation data. The mobile device may include application software for communicating with the server. The system may also include an administration application that notifies an administrator when a change in a device's geolocation may trigger an action item. The administrator may act on the action item, for example, by modifying one or more service plans associated with the device to enable or disable certain account for the change in the device's location.

Other systems, methods, features and technical advantages of the invention will be, or will become apparent to one with skill in the art upon examination of the following figures and detailed description. It is intended that all such additional systems, methods, features and technical advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 shows an exemplary physical architecture for an exemplary system for monitoring a devices geolocation;

FIG. 2 shows an exemplary functional architecture for an exemplary system for monitoring a devices geolocation;

FIG. 3 shows an exemplary flowchart for a registration process for an exemplary system for monitoring a devices geolocation;

FIG. 4 shows a flowchart for an exemplary monitoring/notification process for an exemplary system for monitoring a devices geolocation;

FIG. 5 shows a flowchart showing an exemplary use case in which an exemplary device geolocation monitoring server initiates communication with a client application;

FIG. 6a shows a flowchart showing an exemplary use case in which an administrator uses an exemplary administration application with an exemplary geolocation monitoring server;

FIG. 6b shows a flowchart showing an exemplary use case in which an exemplary geolocation monitoring server adjusts a user's coverage area; and

FIGS. 7-12 show exemplary screen shots for an exemplary administration application for an exemplary system for monitoring a device's geolocation.

### DETAILED DESCRIPTION OF THE PREFERRED EMBODIMENTS

The elements illustrated in the Figures interoperate as explained in more detail below. Before setting forth the detailed explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the contact management system architecture may be stored on, distributed across, or read from other machine-readable media, for example, secondary storage devices such as hard disks, floppy disks, and CD-ROMs; a signal received from a network; other forms of ROM or RAM either currently known or later developed; and the like.

Furthermore, although specific components of the communications architecture will be described, methods, systems, and articles of manufacture consistent with the contact management system architecture may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, and other data structures may be separately stored and managed, may be incorporated into a single memory or database, may be distributed, or may be logically and physically organized in many different ways, including unstructured data. Programs may be parts of a single program, separate programs, or distributed across several memories and processors. Systems may be implemented in hardware, software, or a combination of hardware and software in one processing system or distributed across multiple processing systems.

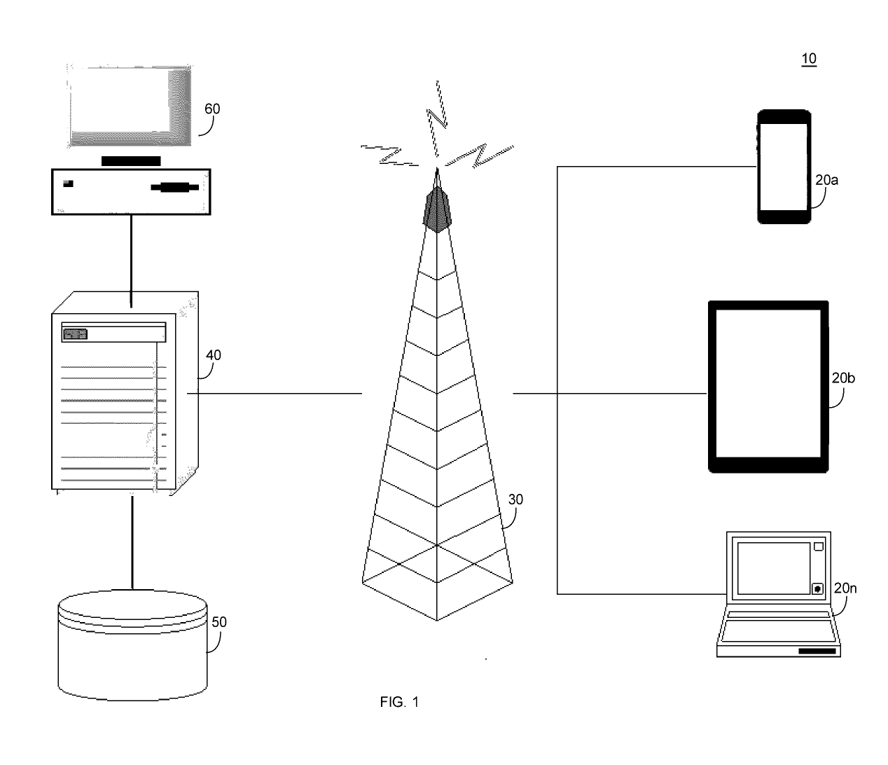

Referring to FIG. 1, an exemplary architecture 10 for a device geomonitoring system is shown. One or more mobile devices may run client applications 20a-n may communicate with a device geolocation monitoring server 40 via a communications network 30 (shown as an exemplary cell tower). The mobile devices 20a-n may provide geolocation information to a device geolocation monitoring server 40. In response, the server 40 may modifying one or more services associated with the mobile devices 20a-n based on the received device geolocation information. The server 40 may store information in a database 50 and also may provide an administration interface 60 that enables an administrator to interact with the server 40.

Although references will now be made to specific components of the system performing specific features, it should be apparent to one of ordinary skill in the art that such references are exemplary and are not intended to limit the scope of the claims in any way; furthermore, the functionalities described herein may be implemented in a virtually unlimited number of configurations. For example, although figuratively attached to the device geolocation monitoring server 40, the database 50 may, in practice, distribute user-specific data elements directly to one or more client systems 20a, 20b, and 20n. Similarly, the device geolocation monitoring server 40 may be implemented as a single server configured to provide all of the system's functionalities, or the functionalities may be implemented across multiple servers.

The client applications 20a-n may provide a user interface for the system 10 and may communicate device profile and other information with device geolocation monitoring server 40 via communications network 30. In one embodiment, client systems 20a-n may comprise stand-alone applications which may be either platform dependent or platform independent. For example, client systems 20a-n may be stand-alone applications for a mobile phone configured to run on a mobile operating system such as the iOS™ operating system from Apple Inc. located in Cupertino, Calif., the Android™ operating system from Google, Inc. located in Mountain View, Calif., or the like. Alternatively, or additionally, client systems 20a-n may connect to the device geolocation monitoring server 120 via the Internet using a standard browser application. Alternatively, or additionally, one or more of the client systems 20a-n may be an application configured to run on mobile computer such as a laptop computer, handheld computer, tablet, mobile messaging device, or the like which may all utilize different hardware and/or software packages. Other methods may be used to implement the client applications 20a-n.

The communications network 30 may be any type any private or public communication network, such as the Internet, and may include one or more communications networks. In some embodiments, the communications network 30 may be a cellular network such as, for example, a Code Division Multiple Access (CDMA) network, Global System for Mobiles (GSM) network, General Packet Radio Service (GPRS) network, cdmaOne network, CDMA2000 network, Evolution-Data Optimized (EV-DO) network, Enhanced Data Rates for GSM Evolution (EDGE) network, Universal Mobile Telecommunications System (UMTS) network, Digital Enhanced Cordless Telecommunications (DECT) network, Digital AMPS (IS-136/TDMA), Integrated Digital Enhanced Network (iDEN) and the like.

The device geolocation monitoring server 40 may store device information in a database 50, receive device registration and geolocation information from a client application 20a-n, communicate various status information to a client application 20a-n, communicate with various service providers (such as cellular service providers), provide a user interface for an administration application 60, and the like. In operation, the device geolocation monitoring server 40 and client systems 20a-n may, for example, allow a user to register a device with the device geolocation monitoring server 40, automate monitoring of a registered device's geolocation, and modify coverage areas associated with a registered device on demand. As should be apparent to one of ordinary skill in the art from the disclosure herein, other related services may also be provided.

A user may be an individual, a commercial entity, or any other type of entity. A device may also be considered a user in that information may be stored for a particular user, a particular device, or both. For example, an organization may be associated with a plurality individual users (employees) or devices that share a pool of available service plans associated with various coverage areas, thereby the individual users or devices associated with the organization to share the service plans and associate any of the plans with any of the users or devices, as described herein. In some embodiment, individual users may be associated with more than device.

The database 50 may store a variety of information, including device information, user profile information, user preference information, company information, service plan information, device status history, alert and/or notification information, and the like. Exemplary table definitions are described below in tables 1.0-5.0. An exemplary set of data fields stored in the database for a device is shown in the following table 1.0:

TABLE 1.0
Exemplary Device Data Fields

| Data Field | Description |
|---|---|
| DEVICE ID | Identifier for the device |
| PHONE NUMBER | The phone number associated with the device |
| CUSTOMER NAME | Identifier for a company associated with the |
| | device |
| USER NAME | Identifier for a user associated with the device |
| CARRIER | Identifier for the carrier associated with the |
| | device |
| STATUS | Device status |
| APP INSTALLED | Identifier for whether the client application is |
| | installed on the device |
| CHECK-INS | Identifier for whether the device has reported its |
| | geolocation to the server |
| NOTIFICATIONS | Identifier for whether the user has enabled |
| | notifications on the device |
| LOC SERVICES | Identifier for whether the user has enabled |
| | location services on the device |

The device table may store information about a device. For example, in the exemplary table, the following data fields may be stored: a device_id data field that may be a unique identifier for the device: a customer_name data field may indicate a company associated with the device; a phone_number data field may indicate a phone number associated with the device; a carrier data field may indicate one or more service provider(s) associated with the device; a region data field that may indicate the current region of the device; an employee data field that may indicate an employee or person associated with the device; an alert_type data field that may indicate the type of alert; a reported data field that indicates the time of the alert; a status data field may indicate the status of the device (such as active, needs attention, inactive, any relevant device settings and the like); an app_installed data field may indicate whether a client application is installed on the device; a check-ins data field may indicate whether the device has reported its geolocation to the server; a notifications data field may indicate whether notifications are enabled on the device; and a loc_services data field that may indicate whether locations services are enabled on the device. More or less information about a device may be stored.

An exemplary set of data fields stored in the database for device details is shown in the following table 2.0:

TABLE 2.0
Exemplary Device Details Data Fields

| Data Field | Description |
|---|---|
| PHONE_COUTRY_CODE | The country code for corresponding to |
| | the current region of the phone |
| PHONE_NUMBER | The phone number associated with the |
| | device |
| DEVICE_TYPE | The type of device |
| CARRIER | The carrier associated with the device |
| PLATFORM | The operating system of the device |
| FIRST_NAME | The first name of a user associated with |
| | the device |
| LAST_NAME | The last name of a user associated with |
| | the device |
| EMAIL | The email address of a user associated |
| | with the device |
| HOME_REGION | The default region of the device |
| REGISTRATION_CODE | Identifier used for authentication purposes |
| ACTIVE | Identifier used to indicate whether the |
| | device's geolocation is being monitored |

The device details table may store current status information for a device. For example, in the exemplary table, the following data fields may be stored: a phone_country_code data field may indicate the country code for the current geolocation of the device; a phone_number data field may indicate a phone number associated with the device; a device_type data field may indicate a type of device, such as cell phone, tablet, laptop computer and the like: a carrier data field may indicate one or more service provider(s) associated with the device; a platform data field may indicate an operating system and/or version running on the device; a first_name data field may indicate the first name of a user associated with the device; a last_name data field may indicate the last name of a user associated with the device; an email data field may indicate an email address of a user associated with the device; a home_region data field that may indicate the default (or typical) region for the device; an employee data field that may indicate an employee or person associated with the device; an alert_type data field that may indicate the type of alert; a registration_code data field may be an identifier used for authentication purposes; and an active data field may be an identifier used to indicate whether the device's geolocation is being monitored. More or less information about device details may be stored.

An exemplary set of data fields stored in the database for a customer is shown in the following table 3.0:

TABLE 3.0
Exemplary Device Data Fields

| Data Field | Description |
|---|---|
| CUSTOMER_ID | Identifier for the customer |
| CUSTOMER_NAME | Identifier for a company associated with the |
| | device |
| CONTACT_NAME | Identifier for a user associated with the device |
| STATUS | Customer status |

The device table may store information about a device. For example, in the exemplary table, the following data fields may be stored: a customer_id data field that may be a unique identifier for the customer: a customer_name data field may indicate a name associated with the company; contact_name data field that may indicate a name for a person to contact at the customer; and a status data field may indicate the status of the device (such as active, inactive and the like). More or less information about a customer may be stored.

An exemplary set of data fields stored in the database for customer details is shown in the following table 4.0:

TABLE 4.0
Exemplary Customer Details Data Fields

| Data Field | Description |
|---|---|
| CUSTOMER_NAME | The name of the |
| | customer |
| PRIMARY_CONTACT_NAME | The phone number |
| | associated with the |
| | primary contract for |
| | the customer |
| ACCOUNT_NUMBER | Identifier for the |
| | customer |
| PRIMARY_CONTACT_EMAIL | The email address |
| | of a primary contact |
| | for the customer |
| ACTIVE | Identifier used to |
| | indicate if the user's |
| | individual online |
| | account is active |
| IPA_ACTIVE | Identifier used to |
| | indicate whether |
| | that customer's |
| | device's |
| | geolocations are |
| | being monitored |
| USER/ADMIN_CHECK-IN_ALERT | The maximum |
| | duration a device |
| | can go without |
| | reporting its |
| | location before |
| | notifying the user |
| | and admin via email |
| ALERT_TO_EMAIL | The email address |
| | of a user to |
| | contact in the |
| | event of an alert |
| APP_CHECK_IN_FREQUENCY | The frequency with |
| | which a device |
| | associated with a |
| | customer reports |
| | its geolocation |
| MINIMAL_SEQUENTIAL_COUN- | A minimum |
| TRY_CHANGES | number of |
| | sequential region |
| | changes to trigger |
| | a plan change |
| ESCALATE_AFTER | Conditions for |
| | escalating an alert |
| ESCALATE_TO_EMAIL | Email address to |
| | contact if an |
| | escalation occurs |

The device details table may store additional details about a customer. For example, in the exemplary table, the following data fields may be stored: a customer_name data field may indicate the name of the customer; a primary_contact_name data field may indicate the phone number associated with the primary contract for the customer; an account_number data field may indicate identifier for the customer; a primary_contact_email data field may indicate the email address of a primary contact for the customer; an active data field may indicate if the user's account is active and can be accessed online; an IPA_{—} ACTIVE data field may indicate whether that customer's device's geolocations are being monitored; a USER/ADMIN_CHECK-IN_ALERT data field may indicate the maximum duration a device can go without reporting it's geolocation before notifying the user and administrator via email; an alert_to_email data field may indicate the email address of a user to contact in the event of an alert; an app_check_in_frequency data field may indicate the frequency with which a device associated with a customer reports its geolocation; a minimal_sequential_country_changes data field may indicate a minimum number of sequential region changes to trigger a plan change for devices associated with that customer; an escalate_after data field may indicate conditions for escalating an alert (such as no response after a predetermined time, number of contact events, and the like); an escalate_to_email data field may indicate an email address to contact if an escalation occurs. More or less information about customer details may be stored.

In some embodiments, the device geolocation monitoring server 40 and database 50 may comprise one or more instances of an Amazon Elastic Compute Cloud™ (Amazon EC2™) Web Server (Amazon™) utilizing one or more of the following storage mechanisms: Amazon Simple Storage Service™ (Amazon S3™), Amazon Relational Database Service™ (Amazon RDS™), Amazon SimpleDB™ and Amazon Simple Queue Service™ (Amazon SQS™). For example, each set of contact information for a given user may be stored in one or more Amazon RDS™, user images may be stored in one or more Amazon S3™, and requests to the server 40 may be stored in one or more Amazon SQS™.

In some embodiments, the system 10 may include an administration application 60. The administration application 60 may be provided by the device geolocation monitoring server 40 to, for example, as a stand-alone application running on a computer such as a workstation computer, laptop computer, handheld computer, tablet, mobile messaging device, or the like which may all utilize different hardware and/or software packages. Alternatively, or additionally, administration application 60 may connect to the device geolocation server 40 via the Internet using a standard browser application. A browser based implementation allows system features to be accessible regardless of the underlying platform of the administration application 60. Other methods may be used to implement the administration application 60. In operation, the administration application 60 may provide a framework that allows an administrator to register devices, monitor geolocations for devices, modify service plans associated with device, receive various notifications or alerts, and the like. As should be apparent to one of ordinary skill in the art from the disclosure herein, other related services may also be provided.

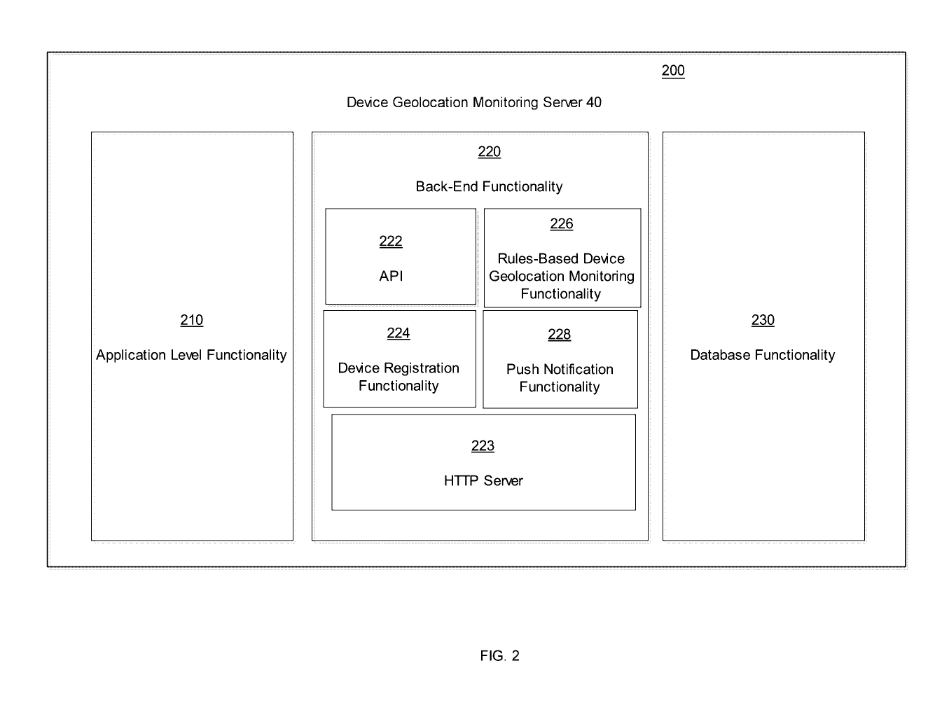

An exemplary functional architecture 200 for a device geolocation monitoring server 40 is shown in FIG. 2. The architecture 200 may include application level functionality 210, back-end server functionality 220, and database functionality 230. Other types of databases, such as eXstensible Markup Language (XML) databases and other storage mechanisms also may be used.

The application level functionality 210 may provide a user interface that implements the administration interface 60 that allows an administrator to perform various functions as described herein. Database functionality 230 provide mechanisms for storing and/or retrieving information from the database 50.

Back-end server functionality 220 may provide functions and control mechanisms for implementing the device geolocation monitoring server 40. In one embodiment, back-end server functionality 220 includes an API 222 for interfacing with the application level functionality 210, a hyper-text transfer protocol (HTTP) server 223, device registration functionality 224, rules-based device geolocation monitoring functionality 226, and push notification functionality 228.

The HTTP server 223 may be an Apache HTTP Server (provided by the Apache Software Foundation), or any other suitable HTTP server. Other communications servers may be used. In operation, HTTP server 223 may receive requests and/or information such as device registration requests and/or geolocation information from user clients 20a-n, processes the information and take appropriate actions in conjunction with the device registration functionality 224 and/or rules-based device geolocation monitoring functionality 226, and provides responses to the user clients 20a-n in conjunction with the push notification functionality 228. The HTTP server 223 may also receive requests and/or information from an administrator application 60, process the information and take appropriate action in conjunction with the application level functionality 210, and provide information and/or responses to the administrator application 60.

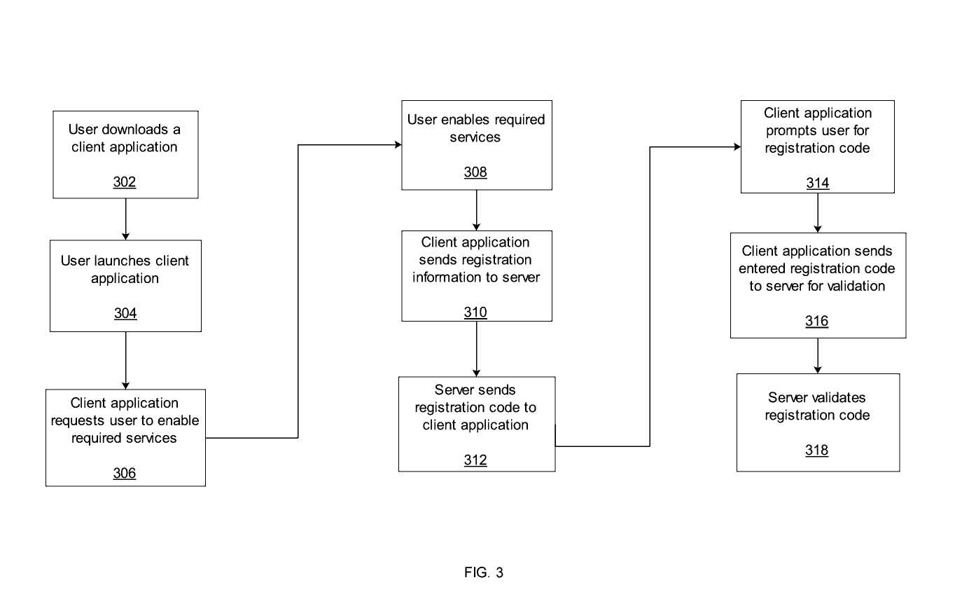

The device registration functionality 224 may provide a framework for registering a device associated with a client application 20a-n with the device geolocation server 40. FIG. 3 shows a flowchart for an exemplary device registration process 300. A user may download a client application (or app) 20a to the mobile device at step 302. For example, the user may download a client application 20a from the APP STORE for mobile devices running the iOS operating system (both of which are provided by Apple, Inc. located in Cupertino, Calif.) or from the PLAY STORE for devices running the Android operating system (both of which are provided by Google, Inc. located in Mountain View, Calif.). In some embodiment, a company may provide employees with a uniform resource locator (URL) along with a registration code; the client application 20a may be downloaded in response to the user activating the URL.

Next, the user may run or launch the client application 20a at step 304, and, in response, the client application 20a may request that and/or provide a mechanism that allows for a user to enable any required services at step 306. For example, in some embodiments, required services may include device push notification services, device location services and SMS text services. In other embodiments, more or less services may be required. In response, the user may enable the required services at step 308. Once the required services have been enabled, the client application 20a-n may send device registration information to the device geolocation monitoring server 40 as step 310.

As noted above, in some embodiments, the device registration code may be provided by a company to an employee. Alternatively, or additionally, the device registration code may be sent by the device geolocation monitoring server 40 to the device, such as via a text message or other methods, upon receiving notification that the push notification and location services have been enabled on a particular device at step 312. The client application 20a may provide a device registration screen that provides user interface controls that enable the user to enter the device registration code at step 314. The user may enter the code at step 316 and the client application 20a may transmit the device registration code to the device geolocation server 40, which may validate the code and register the device at step 318.

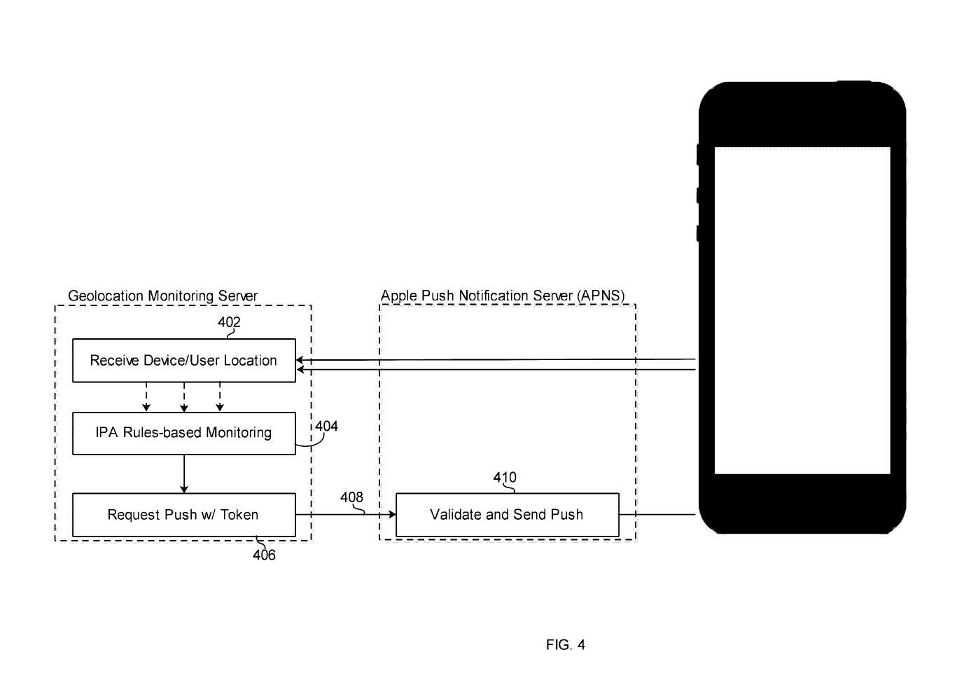

Referring again to FIG. 2, the rules-based device geolocation monitoring functionality 226 may provide a framework for how the device geolocation server 40 monitors the geolocation of a given device. A flowchart for an exemplary use case for a client application running on the iOS operating system is shown in FIG. 4. In normal operation, the client application 20a may run in the background whenever the device is on. Periodically, the client application 20a may transmit device geolocation information, such as a latitude and longitude for the device, to the device geolocation monitoring server 40 at step 402. In response, the device geolocation server 40 may apply monitoring rules to information at step 404. If necessary, the device geolocation server 40 may generate a targeted and/or custom notification at step 406. The notification may be transmitted to a validation server (the Apple Push Notification Server (APNS) provide by Apple, Inc. located in Cupertino, Calif. in the illustrated example) at step 408, which in turn validates the notification and transmits the notification to the device at step 410.

In some embodiments, the device geolocation monitoring server 40 applies various rule to determine whether a device's has changed and whether any actions may be necessitate by the change. It should be noted that an action may or may not be necessitated by a change in a device's geolocation. Alternatively, or additionally, the client application 20a-n may apply rules to determine if a device's geolocation has changed. In a basic example, a rule may indicate that a change in a device's geolocation has occurred if the latitude and/or longitude of the device is different from the last known latitude and/or longitude of the device. As another example, a rule may indicate that an action should be taken only if a significant location change has occurred. For example, a significant location change may occur if the device's current geolocation is outside of a coverage area, which may be determined by comparing the current latitude and/or longitude of the device to a known range of acceptable latitudinal and longitudinal values.

In a more sophisticated example, an action may be necessitated only if the device's geolocation remains outside of the cover are for a given number of successive updates (such as five consecutive updates) or a predetermined period of time (such as 10 minutes). A rule such may reduce the possibility of erroneous geolocation data cause by corrupted data or where a device is near a service area boundary and may connect to bounce back and forth between communication networks 30 inside and outside an associated service area. Other rules may also be applied.

In some embodiments, the client application 20a-n may indicate to the device geolocation monitoring server 40 whether notifications and/or location services are enabled every time geolocation data is transmitted to the server 40. In other embodiments, the client application 20a-n may indicate to the device geolocation monitoring server 40 whether notifications and/or location services are enabled only when there is a change in status for one or more of the services (i.e. one of the services has been disabled, re-enabled, etc.)

If the device geolocation monitoring server 40 determines that one or more of the required services is disabled, the server 40 may send a notification to the device prompting the user to re-enable the service. In some embodiments, an alert may be generated and/or forwarded to an administrator if the settings are not enabled after a certain condition is met. For example, a user may be given a time period in which to re-enable the service, such as five minutes, one hour, or the like. Other conditions, such as if the server 40 sends more than a predetermined number of notifications to a given user, may be used.

As should be apparent to one of ordinary skill, the monitoring of a device's geolocation may be delayed or prevent in certain scenarios. For example, geolocation monitoring may be delayed if a device is turned off, in airplane mode, not connected to a communications network 30. Similarly, geolocation monitoring may be prevented if, for example, the user has uninstalled the client application 20a-n or turned off one or more required services such as location services. In these scenarios, the client application 20a-n will not report geolocation information to the device geolocation monitoring server 40.

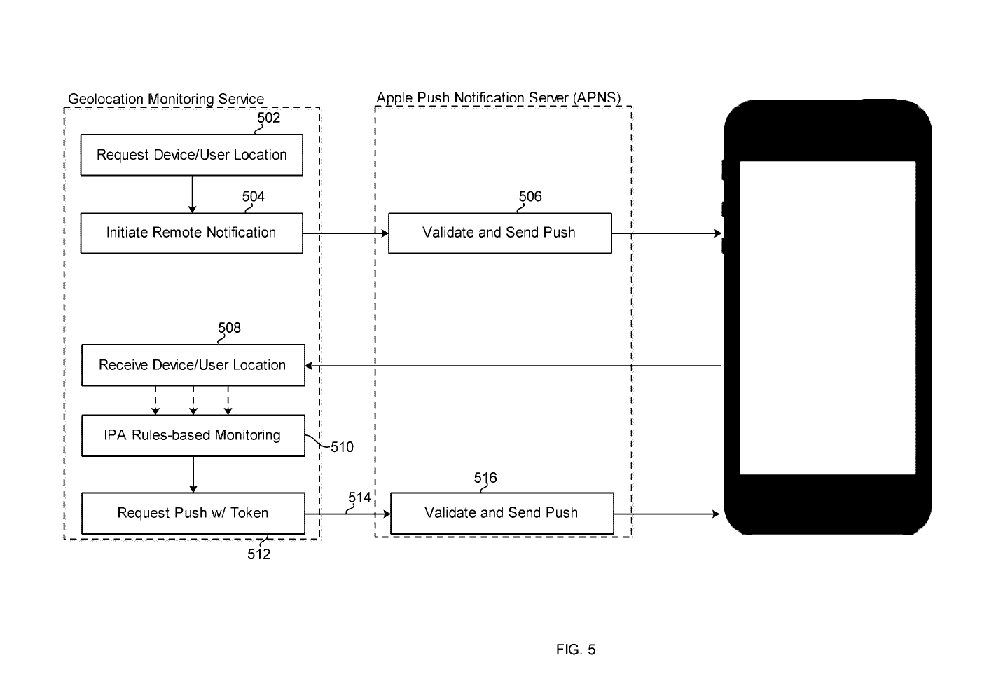

The device geolocation monitoring server 40 may run a process periodically, such as every hour, two hours and the like, to identify any registered devices that have not “checked in” within “n” hours, such as every twenty-four hours or the like. In some embodiments, the device geolocation monitoring server 40 may request geolocation from such devices. An exemplary flowchart showing a use case in which the device geolocation monitoring server 40 initiates communication with a client application 20a-n is shown in FIG. 5. As illustrated, the device geolocation monitoring server 40 may determine that a device has not “checked-in” for request geolocation from a device at step 502. The device geolocation monitoring server 40 may format a request for geolocation data at step 504. The notification may be transmitted to a validation server (the Apple Push Notification Server (APNS) provide by Apple, Inc. located in Cupertino, Calif. in the illustrated example) at step 506, which in turn validates the notification and transmits the notification to the device at step 508. If the request is received by the client application 20a-n, the client application may provide the request geolocation information at step 510 in which case the geolocation data is processed by the device geolocation monitoring server 40 as described above for a typical use case.

In some cases, the device geolocation monitoring server 40 may not receive a response from a device to the request for geolocation data. For each such device, the server 40 may generate an alert for the device that includes information that may assist an administrator to determine a proper course of action. An exemplary set of data fields stored in the database for an alert is shown in the following table 5.0:

TABLE 5.0
Exemplary Alert Data Fields

| Data Field | Description |
|---|---|
| ALERT_ID | Identifier for the alert |
| CUSTOMER | Identifier for the customer account |
| DEVICE | Identifier for the subject device |
| REGION | Identifier for the current region for the |
| | device |
| CARRIER | Identifier for the carrier for the device |
| EMPLOYEE | Identifier for the employee associated with |
| | the subject device |
| ALERT_TYPE | Type of alert triggered |
| REPORTED | Time the event was identified |
| STATUS | Status of the alert |
| ASSIGNED | Identifier of the administrator assigned to |
| | handle the alert |

In the exemplary table, an alert may include the following data fields: an alert_id data field that may be a unique identifier for the alert: a customer data fields that may indicate a company associated with the device associated with the alert; a device identifier that may indicate the device or user (such as by user name, label or the like); one or more carrier identifiers that may indicate any service provider(s) associated with the device or company; a region data field that may indicate the current region of the device; an employee data field that may indicate an employee or person associated with the device; an alert_type data field that may indicate the type of alert; a reported data field that indicates the time of the alert; a status data field that may indicate the status of the alert (such as active, needs attention, inactive, and the like); and an assigned data field that may indicate an administrator that been assigned to handle the alert. An alert may include more or less information. Exemplary alerts types may include a no longer roaming alert, a device not checking in alert, a notifications disabled alert, a location services disabled alert and the like.

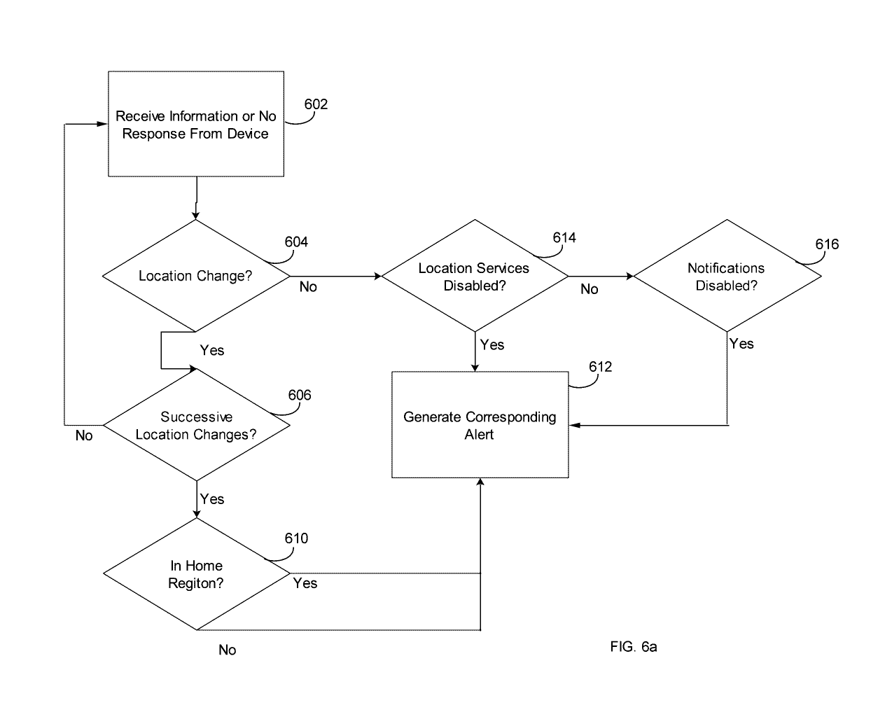

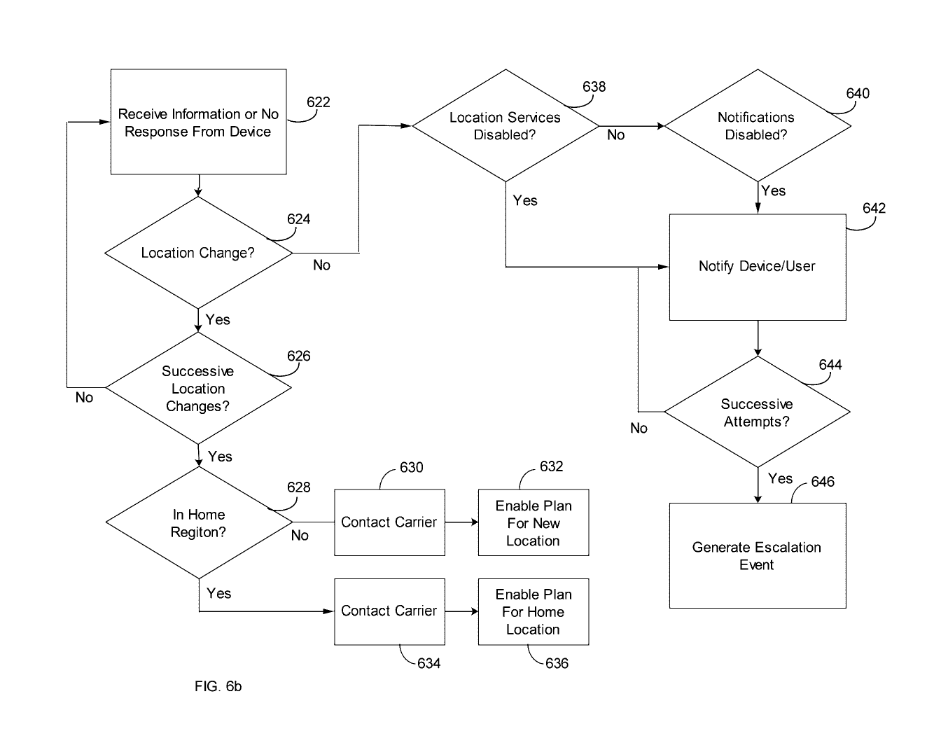

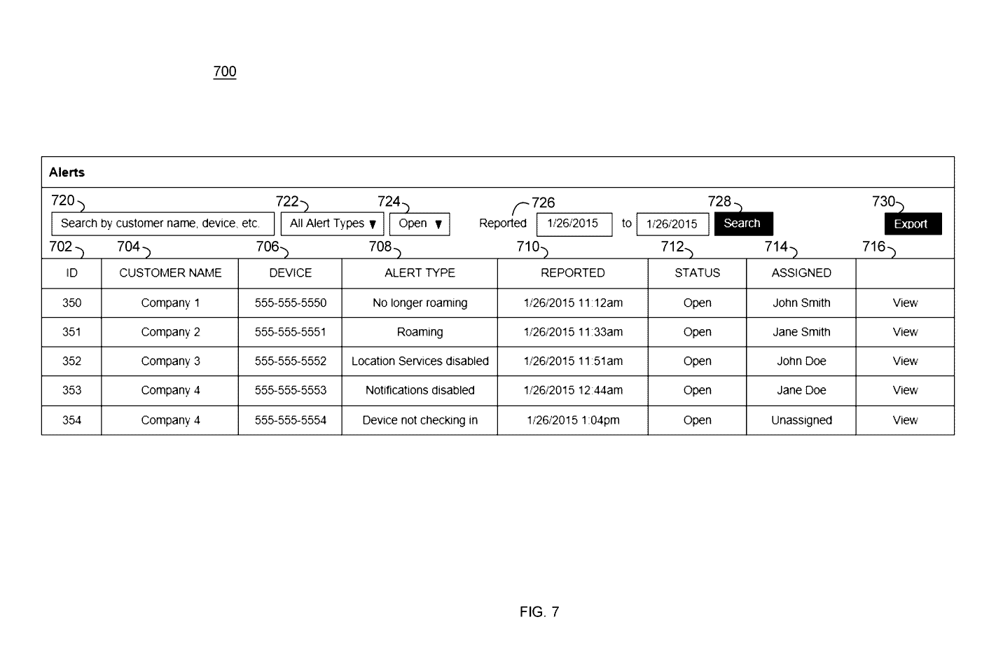

FIG. 6a shows a flowchart showing an exemplary use case in which an administrator uses an exemplary administration application with an exemplary geolocation monitoring server. In the illustrated example, the server 40 may either receive information device and/or not receive a response from a device at step 602. Next, the server 40 may determine if the information indicates a location change at step 604, and, if so, if the same new location has been indicated by the device the minimum number of times at step 606. If so, the server 40 may determine if the current location of the device is the home region associated with the device at step 610. If the location is not the device's home location, the server may generate an corresponding alert at step 612, which in this case indicates that the device is roaming and/or that a new plan for the current location should be enabled. If the location is the device's home location, the server may generate an corresponding alert at step 612, which in this case indicates that the device is no longer roaming and/or that any roaming plan should be disabled and/or the default plan should be re-enabled. These alerts may be assigned to and/or communicated to an administrator, such as via the administration utility described below in reference to FIG. 7-12, to take any actions necessary to deal with the alert(s).

If the server 40 does not receive information indicating a location change at step 602 (which may be determined at step 604), such as if the server 40 does not receive a response from a device, the server 40 may determine if the location services have been disable on the device at step 614. If so, the server may generate a corresponding alert at step 612, which in this case indicates that the location services have been disabled on the device and should be re-enabled. The server 40 may also determine if notifications have been disable on the device at step 616, and, if so, may generate a corresponding alert at step 612, which in this case indicates that notifications have been disabled on the device and should be re-enabled. Once again, these alerts may be assigned to and/or communicated to an administrator, such as via the administration utility described below in reference to FIG. 7-12, to take any actions necessary to deal with the alert(s).

FIG. 6b shows a flowchart showing an exemplary use case in which an exemplary geolocation monitoring server adjusts a user's coverage area. In the illustrated example, the server 40 may either receive information device and/or not receive a response from a device at step 622. Next, the server 40 may determine if the information indicates a location change at step 624, and, if so, if the same new location has been indicated by the device the minimum number of times at step 626. If so, the server 40 may determine if the current location of the device is the home region associated with the device at step 610. If the location is not the device's home location, the server may directly contact the carrier's portal at step 630 and enable a new plan for the current location at step 632. If the location is the device's home location, the server may directly contact the carrier's portal at step 634 and disabled a roaming plan and/or re-enable the default plan at step 636.

If the server 40 does not receive information indicating a location change at step 622 (which may be determined at step 624), such as if the server 40 does not receive a response from a device, the server 40 may determine if the location services have been disable on the device at step 638. If so, the server 40 may send a message to the device to notify a user that location services have been disabled on the device and should be re-enabled. The server 40 may also determine if notifications have been disable on the device at step 640, and, if so, may send a message to the device to notify a user that notifications have been disabled on the device and should be re-enabled. Alternatively, or additionally, the server 40 may use other contact methods, such as contacting another user or device associated with the customer, at step 642. If the server does not receive an indication that either location services or notification have been reenabled after a predetermined number of successive attempts (step 644), the server 40 may general an escalation event at step 646. The escalation event may include additional actions intended to address the outstanding issue, such as notifying an alternate contact, such as a supervisor or account administrator. Other actions may also be taken.

In other embodiments, various aspects of the embodiments described in FIGS. 6a and 6b may be combined. For example, roaming plans may be automatically enabled by the server 40 directly contacting a carrier portal, while communications regarding location services and/or notifications services being disabled may be handled by an administrator via an alert. Other combinations may be used. Alternatively, or additionally, the system 10 may include both alerts and server 40 actions for the same event. For example, the server 40 may automatically communicate with a device if location services are disabled and may also generate an alert to notify an administrator of the issue.

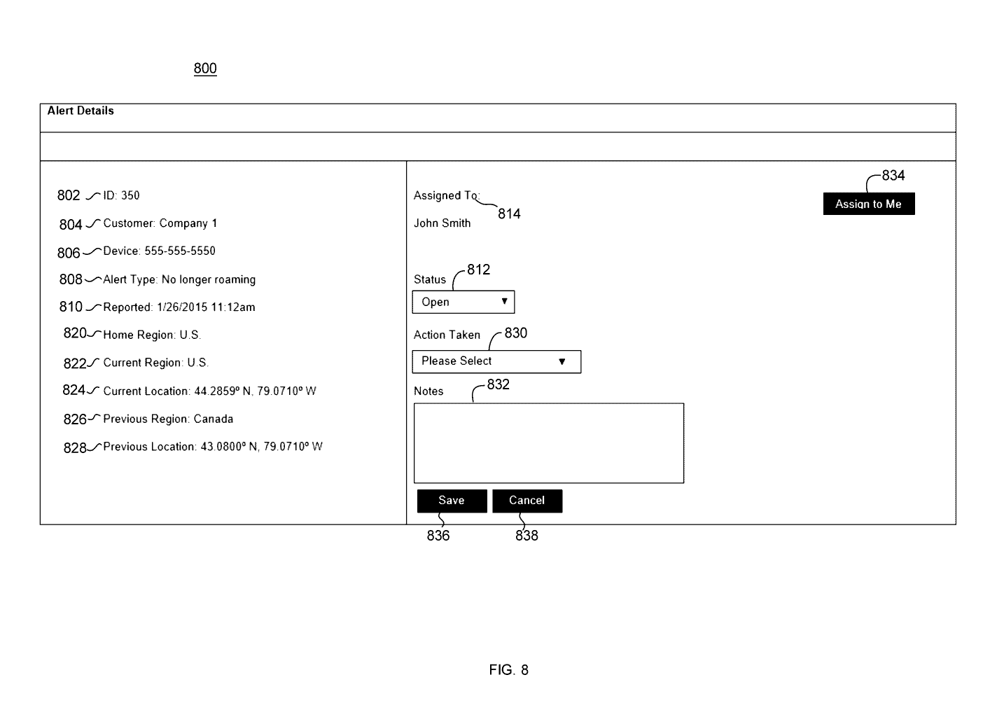

Various screen shots for an administration application 60 are shown in FIG. 7-12. Screen shots of an exemplary list of alerts and an exemplary alert detail page for an administration application 60 are shown in FIGS. 7 and 8. In the embodiment illustrated in FIG. 7, the alert list page 700 may provide a table indicating, for each alert, an ID 702, a customer 704, a device identifier (such as a phone number) 706, an alert type 708, a time when the alert was reported 710, a status 712, an administrator assigned to handle the alert 714 and an interface control 716 to view additional details about the alert and/or take action on an alert. The page 700 may also provide interface controls 720-728 to enter search criteria to search for alerts by keyword (720), alert type (722), alert status (724) and date ranges (726). Optionally, a list of alerts may be exported by activing the corresponding interface control 730.

In embodiment illustrated in FIG. 8, an alert detail screen 800 may provide details about an alert, such as an ID 802, a customer 804, a device identifier (such as a phone number) 806, an alert type 808, a time when the alert was reported 810, a status 812, an administrator assigned to handle the alert 814, a home region for the device 820, a current region for the device 822, a current location of the device 824, a previous region for the device 826 and a previous location for the device 828. The alert detail screen may also let an administrator modify the alert status 812, indicate an action taken on the alert 830, provide notes about the alert 832, request that an alert by assigned to the current administrator 834 and save 836 or cancel 838 any changes.

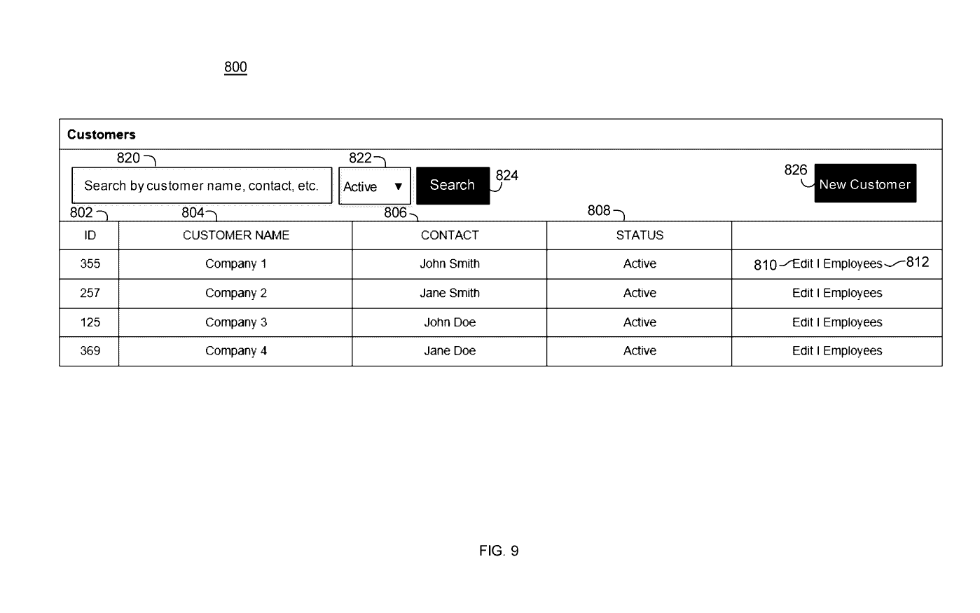

An exemplary customer list screen 900 is shown in FIG. 9. In the illustrated embodiment, the customer list screen 900 may provide, for each customer, an ID 902, a customer name 904, a contact 906, a customer status 908 and interface controls 910 and 912 to view additional details about the customer and/or any employees associated with the customer, respectively. The page 900 may also provide interface controls 920-926 to enter search criteria to search for customers by keyword (920) and/or status (922). Optionally, a list of customers may be exported by activing the corresponding interface control 926.

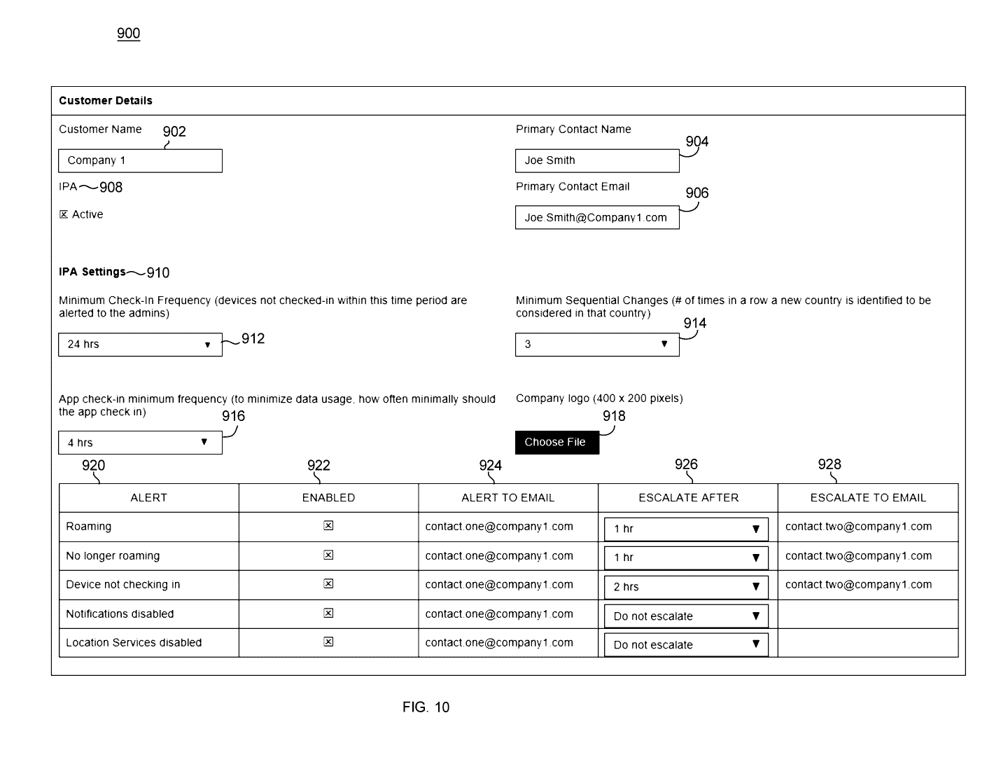

An exemplary customer details screen 1000 is shown in FIG. 10. In the illustrated embodiment, the customer detail screen 900 may provide details about a customer, such as a customer name 1002, primary and secondary contacts 1004 and 1006, and a status 1008. In addition, an administrator may set various customer preferences via the customer details screen 1000, such as a maximum check-in frequency 1012, a minimum sequential country changes 1014, a client application minimum check-in frequency 1016. An administrator may also be able to upload a company logo for use by the administration application 60, the client application 20a-n, or both by activating the corresponding control 1018. In some embodiments, alert preferences may be set for each type of alert 1020, such as for a no longer roaming alert, a device not checking in alert, a notifications disabled alert, and a location services disabled alert. The alert preferences may include whether a particular alert is enabled for the customer 1022, a contact to notify if an alert of the type is triggered 1024, an escalation timer associated with the alert type 1026, and a contact 1028 to notify if an escalation event occurs for the alert type.

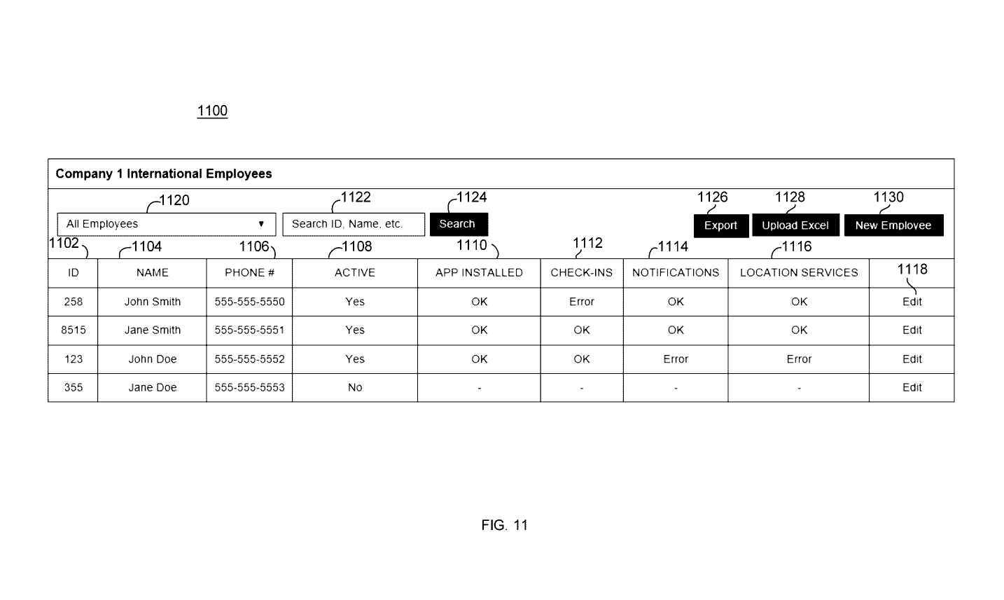

An exemplary employee list screen 1100 is shown in FIG. 11. In the illustrated embodiment, the employee list screen 1100 may provide, for each employee, an ID 1102, an employee name 1104, a device identifier such as a phone number 1106, and an employee status 1108. The employee list screen 1100 may also provide indicators about whether the employee's device has a client application 20a-n installed (1110), whether the device is checking in (1112), whether notification services are enabled on the device (1114) and whether location services are enabled on the device (1116). An interface control 1118 may be provided to view additional details about the employee. The page 1100 may also provide interface controls 1120-1124 to enter search criteria to search for employees by type (1120) and/or keyword (1122). Optionally, interface controls 1126-1130 may be provided to allow an administrator to export a list of employees (1126), upload a list of employees (such as a spreadsheet or other structured file) (1128), and add a new employee (1130).

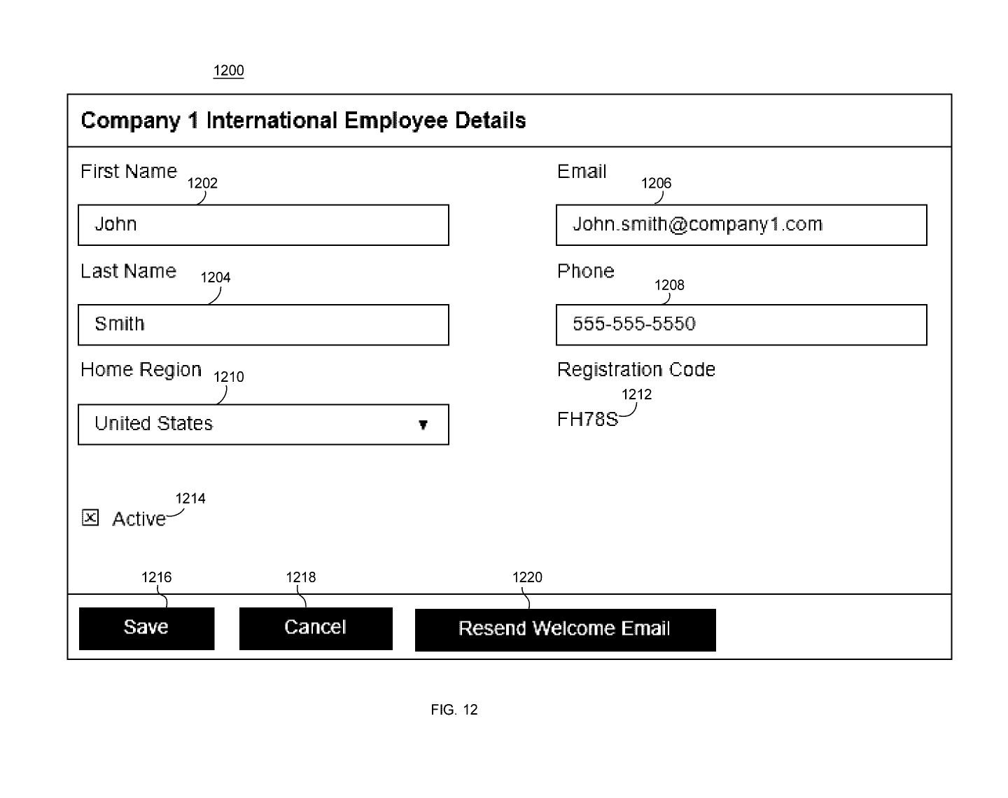

An exemplary employee details screen 1200 is shown in FIG. 12. In the illustrated embodiment, the employee details screen 1200 may allow an administrator to set various details about an employee, such as a first name 1202, last name 1204, email address 1206, phone number 1208, and home region 1210. In addition, a registration code 1212 associated with the employee and an employee status 1214 may be displayed on the screen 1200. The administrator may save or cancel any changed by selecting the appropriate control 1216 and 1218 and may resend a welcome email or registration code by selecting interface control 1220.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for monitoring the geolocation of a mobile device, comprising:
receiving, by a server computer, a first signal indicative of a first geolocation of a mobile device;
determining, by the server computer, if the first geolocation of the mobile device is outside of a principle coverage area associated with a first plan for the mobile device; and
enabling, by the server computer, a second plan associated with a secondary coverage area for the mobile device if the first geolocation of the mobile device is outside of the principle coverage area for the mobile device, where the second coverage area includes the first geolocation.

2. The method of claim 1, further comprising:
receiving, by the server computer, a second signal indicative of a second geolocation of the mobile device;
determining, by the server computer, if the second geolocation of the mobile device is inside the principle coverage area for the mobile device; and
enabling, by the server computer, the first plan for the mobile device if the second geolocation of the mobile device is inside the principle coverage area for the mobile device.

3. The method of claim 1, where the second plan is enabled only if the server receives a predetermined number of signals indicating geolocations of the mobile device that are outside of the principle coverage area for the mobile device.

4. The method of claim 1, further comprising:
sending, by the server computer, a second signal indicative of a request for information indicative of a current geolocation of a mobile device if the server computer does not receive geolocation information from the mobile device after a predetermined period of time.

5. The method of claim 4, further comprising:
generating, by the server computer, an escalation event if geolocation information is not received from the mobile device after either a second predetermined period of time, a predetermined number of requests for geolocation are sent by the server computer, or both.

6. The method of claim 1, further comprising:
receiving, by the server computer, a second signal indicating that location services are disabled on the mobile device;
sending, by the server computer, a third signal indicative of a request for a user associated with the mobile device to enable location services on the mobile device.

7. The method of claim 1, further comprising:
receiving, by the server computer, a second signal indicating that notifications from the server computer are disabled on the mobile device;
sending, by the server computer, a third signal indicative of a request for a user associated with the mobile device to enable notifications on the mobile device.

8. A system for monitoring the geolocation of a mobile device, comprising:
a first software module for use on the mobile device, the first software module including instructions stored on a non-transitory computer readable medium that:
transmit, to a server computer, a first signal indicative of a first geolocation of the mobile device; and
a second software module for use on the server computer, the second software module including instructions stored on a non-transitory computer readable medium that:
receive the first signal from the first software module;
determine if the first geolocation of the mobile device is outside of a principle coverage area associated with a first plan for the mobile device; and
enable a second plan associated with a secondary coverage area for the mobile device if the first geolocation of the mobile device is outside of the principle coverage area for the mobile device, where the second coverage area includes the first geolocation.

9. The system of claim 8, where the first software module further includes instructions that:
transmit, to the server computer, a second signal indicative of a second geolocation of the mobile device; and where the second software module further includes instructions that:
determine if the second geolocation of the mobile device is inside the principle coverage area for the mobile device; and
enable the first plan for the mobile device if the second geolocation of the mobile device is inside the principle coverage area for the mobile device.

10. The system of claim 8, where the second software module further includes instructions that enables the second plan only if the server receives a predetermined number of signals indicating geolocations of the mobile device that are outside of the principle coverage area for the mobile device.

11. The system of claim 8, where the second software module further includes instructions that send a second signal indicative of a request for information indicative of a current geolocation of a mobile device if the server computer does not receive geolocation information from the mobile device after a predetermined period of time.

12. The system of claim 11, where the second software module further includes instructions that generate an escalation event if geolocation information is not received from the mobile device after either a second predetermined period of time, a predetermined number of requests for geolocation are sent by the server computer, or both.

13. The system of claim 8, where the first software module further includes instructions that:
send, to the server computer, a second signal indicating that location services are disabled on the mobile device; and
where the second software module further includes instructions that:
receive the second signal from the first software module, and
send a third signal indicative of a request for a user associated with the mobile device to enable location services on the mobile device.

14. The system of claim 8, where the first software module further includes instructions that:
send, to the server computer, a second signal indicating that notifications are disabled on the mobile device;
and where the second software module further includes instructions that:
receive the second signal from the mobile device; and
send a third signal indicative of a request for a user associated with the mobile device to enable notifications on the mobile device.

15. The system of claim 8, where the first software module further includes instructions that register the mobile device with the server computer.

16. A system for monitoring the geolocation of a mobile device, comprising:
a first software module for use on the mobile device, the first software module including instructions stored on a non-transitory computer readable medium that:
register the mobile device with a server computer;
transmit, to the server computer, a first signal indicative of a first geolocation of the mobile device; and
a second software module for use on the server computer, the second software module including instructions stored on a non-transitory computer readable medium that:
receive the first signal from the first software module;
determine if the first geolocation of the mobile device is outside of a principle coverage area associated with a first plan for the mobile device; and
generate an alert indicative of a request for an administrator to enable a second plan associated with a secondary coverage area for the mobile device if the first geolocation of the mobile device is outside of the principle coverage area for the mobile device, where the second coverage area includes the first geolocation.

17. The system of claim 16, where the first software module further includes instructions that:
send, to the server computer, a second signal indicating that location services are disabled on the mobile device; and
where the second software module further includes instructions that:
receive the second signal from the first software module, and generate an alert indicative of a request for an administrator to request that location services be enabled on the mobile device.

18. The system of claim 16, where the first software module further includes instructions that:
send, to the server computer, a second signal indicating that notifications are disabled on the mobile device;
and where the second software module further includes instructions that:
receive the second signal from the mobile device; and
generate an alert indicative of a request for an administrator to request that notifications be enabled on the mobile device.

19. The system of claim 16, where the second software module further includes instructions that generate the alert only if the server receives a predetermined number of signals indicating geolocations of the mobile device that are outside of the principle coverage area for the mobile device.

20. The system of claim 16, where the second software module further includes instructions that generate a second alert indicative of a request for an administrator to request information indicative of a current geolocation of a mobile device if the server computer does not receive geolocation information from the mobile device after a predetermined period of time.
